(19) United States
(12) Patent Application Publication
(10) Pub. No.: US 2025/0111324 A1
(43) Pub. Date: Apr. 3, 2025

(54) METHOD AND SYSTEM FOR DIFFERENTIATING PERFORMANCE BETWEEN INTEGRATED SOLUTIONS

(71) Applicant: Alpha Assembly Solutions Inc., Waterbury, CT (US)

(72) Inventors: Paul Salerno, Waterbury, CT (US); Anna Lifton, Waterbury, CT (US); Howard Jin, Waterbury, CT (US); Eric Bradley, Waterbury, CT (US); Bruce Moloznik, Waterbury, CT (US); Julia Murray, Waterbury, CT (US)

(21) Appl. No.: 18/897,145

(22) Filed: Sep. 26, 2024

Related U.S. Application Data
(60) Provisional application No. 63/541,640, filed on Sep. 29, 2023.

(51) Int. Cl. G06Q 10/0639; G06Q 50/04

(52) U.S. Cl. CPC G06Q 10/06395; G06Q 50/04

(57) ABSTRACT

A graphical user interface (GUI) to communication evidenced-based value propositions to a customer The tool is capable of presenting interactively compelling evidenced based value and enables engagement of various integrated solutions that can be tailored to specific customer needs. Thus, the tool of the present invention is desired to demonstrate an interface of various integrated solutions to provide evidence-based value propositions for evaluation and consideration by the customer.

### FIELD OF THE INVENTION

The present invention relates generally to a reliability enhancement tool for demonstrating performance capabilities of various integrated solutions in electronics manufacturing which can be indicative of increased performance at the system level.

### BACKGROUND OF THE INVENTION

Integrated material design relates generally to an integrated solution of joining materials in the processing/manufacture of PWB, PCB, interconnects, etc. in electronics manufacture.

These integrated solutions may be, for example, selected from one or two or more specialty electronic materials including, but not limited to, solder pastes, sintering materials, fluxes, chemicals, polymers, metals (in various forms) and films that present themselves in intimate physical contact with each other and with other substrate surfaces in electronics applications when they are put in use.

However, the selection of individual joining materials that make up an integrated solution can lead to undesirable interactions between the materials, leading to for example lower system level reliability or reduced performance of the individual materials. In addition, different electronics applications have different and changeable reliability requirements. Thus, it would be desirable to develop a solution by which these interactions can be evaluated and explored specific to market segment application requirements along with the risk factors associated therewith.

For example, it is known that chemical interactions can alter polymer curing kinetics of polymers. In addition, polymer reinforcement can be more susceptible to surface insulation resistance (SIR) failure at higher thermal profiles. Ineffective underfill materials can result in low adhesion strength or SIR failure. Based thereon, it can be seen that different package designs have different requirements, thus requiring varying/suitable reinforcement strategies.

In joining electronic substrates, one of the major difficulties is in evaluating multiple materials to be used in combination as different materials may be incompatible and the desirability of a certain property for one industry segment/manufacturing sector may be different from another. In addition, most joining materials are only evaluated for their individual properties and a user/customer may have to undertake extensive testing and evaluation of materials and combinations of materials to develop an integrated solution that has the desired properties and characteristics.

Furthermore, an integrated material solution may include one or more solder pastes, sintering materials, fluxes, chemicals, polymers, metals (in various forms), films and components that are integrated/joined together. The materials making up these integrated material solutions must be evaluated for their compatibility (including, e.g., electrochemical reliability, cure characteristics, and/or adhesion) and board level reliability (BLR) (including, e.g., thermal cycling, vibration, drop shock, etc.). Differences in materials costs and processing costs must also be evaluated.

Also, different industry segments may also have different performance requirements that must be met and it would be desirable to streamline and/or simplify this selection of materials. For example, assembly challenges in board level reliability in the automotive sector result in the failure of solder joints over time due to the accumulation of strain. It is known that both package design and operating conditions can contribute to shear strain which leads to creep fatigue.

Thus, it can be seen that the complexity of package design necessitates increased board level reliability through a combination of solutions that combines joining materials in a suitable manner.

### SUMMARY OF THE INVENTION

It is an object of the present invention to provide board level reliability solutions.

It is an object of the present invention to demonstrate performance capabilities of multiple joining materials in an integrated solution of materials.

It is another object of the present invention to minimize poor interaction and/or potential performance issues between incompatible joining materials.

It is another object of the present invention to characterize interdependency of multiple joining materials in an integrated solution for evaluation by a customer/user.

It is another object of the present invention to provide a tool to explain/define/characterize characteristics of a plurality of integrated solutions.

It is still another object of the present invention to demonstrate solutions that overcome potential negative material interactions that can occur in specific applications.

It is still another object of the present invention to validate performance of material solutions and or integrated solutions when one or more joining materials or joining solutions used in combination.

To that end, in one embodiment, the present invention relates generally to a computer-implemented method for demonstrating differentiated performance between integrated solutions used for joining components (PCB, PWB, interconnect, etc.), wherein the computer-implemented method comprises at least a processor to execute instructions, a memory therein to store instructions, and a database populated with data related to joining materials, wherein the database is accessible by the processor, wherein the computer implemented method is executed within a host organization, wherein the method comprises:
executing instructions via the processor, wherein the processor is programmed to (a) access data stored in the database, and (b) generate a graphical user interface (GUI) at a user computing device to display a graphical representation of differentiated performance between a plurality of integrated solutions, wherein each of the plurality of integrated solutions comprises one or more joining materials;
populating the GUI with the data related to the joining materials, wherein the data related to the joining materials and their properties is stored in the database;
transmitting the GUI to the user computing device for display, wherein the GUI displays information to demonstrate differentiated performance between the plurality of integrated solutions,
   wherein the plurality of integrated solutions comprise a baseline integrated solution, wherein the baseline integrated solution comprises a baseline joining material or baseline plurality of joining materials, and a continuum of one or more additional integrated solutions measured against the baseline integrated solution, wherein each of the one more additional integrated solutions comprise one or more additional joining materials in addition to the baseline joining material or baseline plurality of joining materials;
   wherein the GUI is configured to display a graphical representation of the plurality of integrated solutions, wherein the graphical representation provides product properties for each of the plurality of integrated solutions, wherein the product properties of the integrated solution are different from the product properties of individual joining materials that make up the integrated solution,
   wherein the graphical representation is arranged such that one of an X-axis and a Y-axis identifies and displays a property of the integrated solution and the other of the X-axis or Y-axis identifies the integrated solution, wherein the data is arranged so that a first row/column constitutes the baseline integrated solution;
   wherein an intersection of an X- and Y-data point represents a particular property for a particular integrated solution;
wherein the method further comprises:
based on a selection of an intersection of a particular X-Y-data point, generating a pop-up window to display a visualization of product information related to data/support/analysis of the baseline integrated solution or a visualization of product information related to data/support/analysis of the particular integrated solution as compared with the baseline integrated solution to be indicative of increased performance at the system level;
based on a selection of a product property on the X- or Y-axis, generating a pop-up window to display a visualization of information related to test data, performance data, and conditions used to generate the information related to the data/support/analysis of the plurality of integrated solutions; and/or
based on a selection of an integrated solution on the X- or Y-axis, generating a pop-up window to display a visualization of information related to the integrated solution.

In another embodiment, the present invention also relates generally to a system comprising:
a. a processor for executing instructions, wherein the processor is programmed to (a) access data stored in a database, and (b) generate a graphical representation of a plurality of joining materials and their properties;
b. a database populated with data related to the joining materials and their properties, wherein the database is accessible by the processor, and
c. memory operably connected to the processor, the memory having instructions executable by the processor, the instructions including:
   executing via the processor the generation of a graphical user interface (GUI) at a user computing device to display differentiated performance between a plurality of integrated solutions, wherein each of the plurality of integrated solutions comprises one or more joining materials;
   populating the GUI with the data related to the joining materials and their properties;
   displaying the GUI on the user computing device, wherein the GUI displays information to demonstrate differentiated performance between the plurality of integrated solutions,
      wherein the plurality of integrated solutions comprise a baseline integrated solution, wherein the baseline integrated solution comprises a baseline joining material or baseline plurality of joining materials, and a continuum of one or more additional integrated solutions measured against the baseline integrated solution, wherein each of the one more additional integrated solutions comprise one or more additional joining materials in addition to the baseline joining material or baseline plurality of joining materials;
      wherein the GUI is configured to display a graphical representation of the plurality of integrated solutions, wherein the graphical representation provides product properties for each of the plurality of integrated solutions, wherein the product properties of the integrated solution are different from the product properties of individual joining materials that make up the integrated solution,
      wherein the graphical representation is arranged such that one of an X-axis and a Y-axis identifies and displays a property of the integrated solution and the other of the X-axis or Y-axis identifies the integrated solution, wherein the data is arranged so that a first row/column constitutes the baseline integrated solution;
      wherein an intersection of an X- and Y-data point represents a particular property for a particular integrated solution.

In another embodiment, the present invention also relates generally to a computer program product embodied in a non-transitory computer readable medium, the computer readable medium having stored thereon a sequence of instructions which, when executed by a processor causes the processor to execute a method to present differentiated performance data for integrated solutions used for joining components to a user, the method comprising:
providing a series of graphical user interfaces (GUIs) to display (i) integrated solutions for a particular industry segment, manufacturing process, or applications process; and (ii) sequentially display multiple depths of information pertaining to the differentiated performance data for a plurality of integrated solutions;
generating a first graphical user interface comprising one or more first level view icons, the one or more first level view icons displaying a selection of industry segments, manufacturing processes, or applications processes;
upon selection of one of the first level view icons, generating a second graphical user interface, the second graphical user interface displaying information directed to differentiated performance between the plurality of integrated solutions,
   wherein the plurality of integrated solutions comprise a baseline integrated solution, wherein the baseline integrated solution comprises a baseline joining material or baseline plurality of joining materials, and a continuum of one or more additional integrated solutions measured against the baseline integrated solution, wherein each of the one more additional integrated solutions comprise one or more additional joining materials in addition to the baseline joining material or baseline plurality of joining materials;
   wherein the second GUI is configured to display a graphical representation of the plurality of integrated solutions, wherein the graphical representation provides product properties for each of the plurality of integrated solutions, wherein the product properties of the integrated solution are different from the product properties of individual joining materials that make up the integrated solution,
   wherein the graphical representation is arranged such that one of an X-axis and a Y-axis identifies and displays a property of the integrated solution and the other of the X-axis or Y-axis identifies the integrated solution, wherein the data is arranged so that a first row/column constitutes the baseline integrated solution;
   wherein an intersection of an X- and Y-data point represents a particular property for a particular integrated solution.

### BRIEF DESCRIPTION OF THE FIGURES

The accompanying drawings, which are incorporated in and constitute a part of this disclosure, illustrate various example implementations in accordance with the present invention.

In the drawings:

FIG. 1 is a block diagram of an example system for providing an interface of a data set.

FIG. 2 is a flow chart of an example method for providing an interactive experience of a data set.

FIG. 3 is a block diagram of various applications that may present a representation of a data set.

FIG. 4 is a block diagram of various performance spectrum to present data for a particular segment or process.

FIG. 5 is a block diagram of various performance spectrum to present data for specified industry segments.

FIG. 6 is an example of a home screen of an example GUI in accordance with the invention.

FIGS. 7-21 present addition screens of the example GUI in accordance with the invention.

### DETAILED DESCRIPTION OF THE PREFERRED EMBODIMENTS

In one embodiment, the present invention relates generally to a tool (GUI) to communication evidenced-based value propositions to a customer in the electronics industry. The tool is capable of presenting interactively compelling evidenced based values and enables engagement of various integrated solutions that can be tailored to specific customer needs. Thus, the tool of the present invention is desired to demonstrate an interface of various integrated solutions which may include offerings related to joining materials including, for example, solder paste/sintering materials, protection materials, and reinforcement solutions to provide evidence-based value propositions for evaluation and consideration by the customer. The tool also enables a customer to evaluate/mitigate risks associated with negative material interactions that may occur in specific applications or due to incompatible combinations of joining materials, even though the individual joining materials may have desirable properties.

The present invention describes a reliability enhancement tool that comprises an interactive interface that highlights/explains/defines differentiated performance between integrated solutions used for joining components (PCB, PWB, interconnects, etc.), layers, etc. Differentiated performance typically requires extensive testing of various joining material combinations to determine an integrated solution that has desirable interactions and positively impacts system level reliability or performance. The reliability enhancement tool described herein characterizes the interdependency of joining materials and combinations of joining materials when used in integrated solutions in electronics manufacturing, such as at the board level, while reinforcing the importance of selecting a suitable integrated solution as compared with the selection of multiple individual joining materials.

In an example computing device, a data set that contains product information, test data, performance data, etc. of various joining materials, joining solutions, related materials, etc. along with their individual properties and their integrated properties (i.e., including the interaction between two or more joining materials or solutions contained in the data set as determined by empirical test data) is retrieved/retrievable from Data Storage. An interactive visualization of the data set is presented in a graphical user interface (GUI) at a user computing device. The system allows a user to interact with the data to determine an integrated solution that fits their needs based on a visualization of the product information/test data/performance data/assumptions, etc. on the GUI.

The following detailed description refers to the accompanying figures. Wherever possible, the same reference numbers are used in the figures and the following description to refer to the same or similar elements. While an implementation may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention, but instead, the proper scope of the invention is defined by the appended claims.

In addition, while the invention described herein describes a data set that contains product information, test data, performance data, etc. of various joining materials, joining solutions, related materials, etc. along with their individual properties and their integrated properties (i.e., including the interaction between two or more joining materials or solutions contained in the data set as determined by empirical test data), it is also contemplated that the process and method described herein can also be used with a data set that contains different product information and/or different solutions of product solutions based on different interactions and/or trying to solve different problems.

The test data and performance data for the developed integrated solutions are unique in the methods, test vehicle design, preparation, and the insight applied to interpret the data involving multiple joining materials, joining solutions, related materials, etc. that are included in a particular integrated solution. In addition, the data sets in the Data Storage 170 directed to the particular integrated solutions clearly convey that the presented integrated solutions overcome the potential negative material interactions that can occur in specific applications and/or from the use of incompatible materials.

In addition, the insights gained from understanding the risk factors and manners of mitigating risks associated with integrating different materials can also assist a customer with evaluating and selecting a particular integrated solution that meets the needs of the customer, is suitable for the customer's need and does not exhibit any negative material interactions.

Risk factors that may be important when integrating different materials on an assembly include, but are not limited to cure kinetic interactions, surface insulation resistance (SIR), package specific strain vectors, and underfill surface compatibility, among others. In the case of cure kinetic interactions, certain flux chemistries can negatively impact the curing kinetics of polymer epoxies. In order to mitigate risk, an integrated solution must be chosen that is demonstrated to contain compatible joining materials which can be evaluated using the GUI described herein. In addition, moisture may ingress/diffuse through polymer materials which can increase with temperature, resulting in lower surface resistance. Using the GUI described herein, various integrated solutions can be evaluated to choose an integrated solution with proven reliability. In addition, different die to package ratios result in different stress vectors which has an impact on reinforcement design configuration techniques. Using the GUI described herein, various integrated solutions can be recommended based on specific component design characteristics. Finally, certain flux chemistries can inhibit the application of a polymer epoxy by altering its surface tension, causing dewetting. However, by understanding and evaluating different integrated solutions using the GUI described herein, dewetting can be minimized or eliminated.

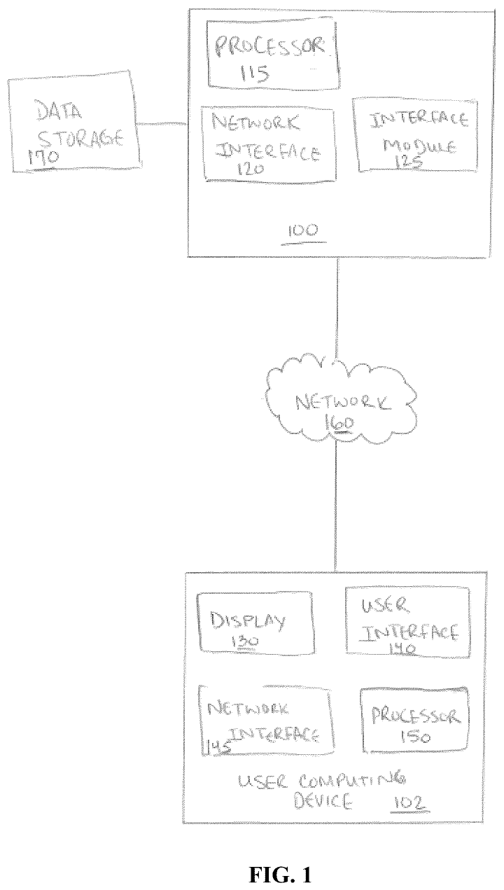

Referring now to the drawings, in which like numerals represent like elements, various embodiments will be described. FIG. 1 is a block diagram illustrating a system architecture with components for allowing user interaction with calculations of data points in charts and with data points in charts associated with a dataset(s). The system architecture includes a computing device 100 and a user computing device 102. The computing device 100 may be one of a variety of suitable computing devices. For example, the computing device 100 or the user computing device 102 may include a tablet computing device, a desktop computer, a mobile communication device, a laptop computer, a laptop/tablet hybrid computing device, a gaming device, or other type of computing device for performing a variety of tasks.

The computing device 100 may include a processor 115, a network interface 120 and an interface module 125.

Data Storage 170 includes one or more data sets containing information related to joining materials, joining solutions, related materials, etc. such as solder paste, other soldering material, sintering materials, adhesives, glue, flux, chemicals, polymers, metals (in various forms), films, protection materials, reinforcement solutions, etc. used for binding, joining, bonding or otherwise connecting components, layers, surfaces, boards (i.e., PWB, PCB), innerlayers, etc. usable in the electronics industry. structures. The information may include product properties, test data and performance data related to individual joining materials and/or joining solutions, and/or related materials, test data and performance data related to integrated solutions of combinations of one or more individual joining materials and/or joining solutions, and/or related materials, risk factors and risk mitigation strategies and insights regarding certain known and perceived risks associated with individual joining materials and incompatible combinations of materials, insights regarding individual materials or combinations of materials, materials costs, usage costs, etc.

Data Storage 170 may be accessed by the computing device 100 via the network 160 or another network. The user computing device 102 may include a processor 150, a display device 130, a user interface 140 and a network interface 145. The network interfaces 120, 145 allow the respective computing devices to communicate with each other or other computing devices over the network 160, which may be, for example, a public or private data network.

A user of the user computing device 102 may request access to a data set stored in the Data Storage 170. This request may be in the form of interaction with a graphical user interface (GUI), such as a webpage, produced by the processor 115 executing the interface module 125. A graphical representation associated with the requested data set is presented to the user via the display device 120. The presented graphical representation includes elements (i.e., data points) linked to one or more subspaces (i.e., supportive test data, etc.) of the requested data set.

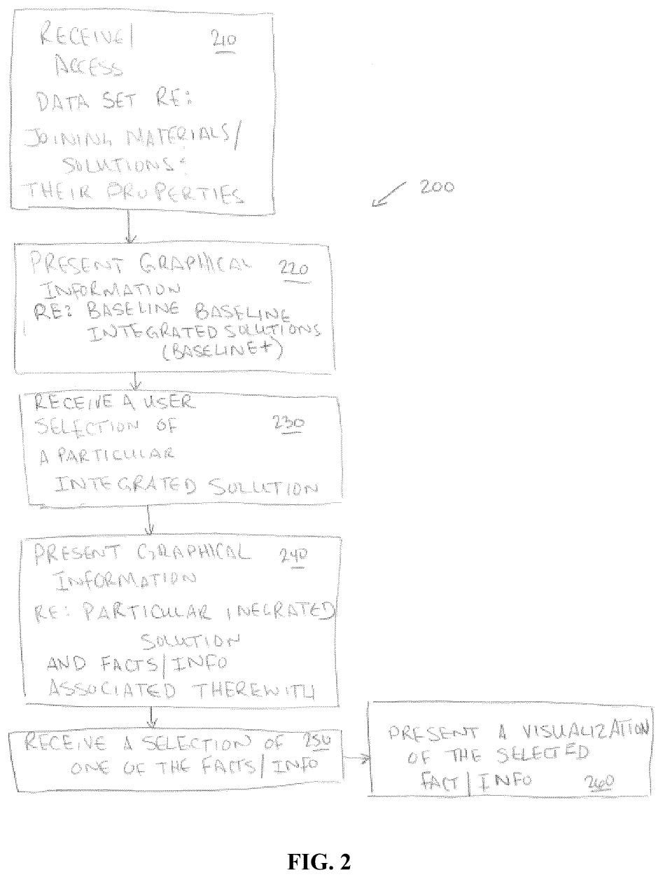

With reference to FIG. 2, aspects of a routine 200 are shown for providing an interactive experience related to a graphical representation of a data set as further described herein.

First, at operation 210, a data set is received or accessed from Data Storage 170, which data sets include data related to a particular set of joining materials/solutions and their properties. The data structure may be stored at the Data Storage 170 or at another remote storage location. The processor 115 may identify data sets that are available for exploration. The processor 115 may present the available data sets in an interface, such as a webpage, accessible by the user computing device 102. A user operating the user interface 140 on the user computing device 102 controls a cursor or other display tool to identify an available data set that the user desires to explore.

At operation 220, a GUI related to the received dataset is presented to a user on the display device 130 of the user computing device 102. The interface module 125 generates the GUI.

Next, at operation 230, the interface module 125 receives, via the user interface 140 and the network interface 145 of the user computing device 102, a selection of a data point located within the presented chart.

At operation 240, in response to the data point selection, a graphical representation of the particular integrated solution and facts and/or information and/or test data and/or performance data associated therewith, are presented to a user on the display device 130 of the user computing device 102. The graphical representation may be presented on one or more separate pages or windows within the GUI.

At operation 250, the interface module 125 receives, via the user interface 140 and the network interface 145 of the user computing device 102, a selection of one of the presented calculated facts/information regarding one of the joining materials/joining solutions. In one example, the selection is made by a cursor activation of a graphical element associated with the calculated fact/information.

At operation 260, the interface module 125 alters the presentation of the visualization associated with the calculated fact/information. For example, a product/property specific information, test data of a combination of joining materials/solutions, performance data of a combination of joining materials/solutions etc. can be presented on the GUI. Operations 230 and 240 or 250 and 260 can be performed multiple times and in multiple sequences to allow a user to view/analyze/consider additional combinations of solutions.

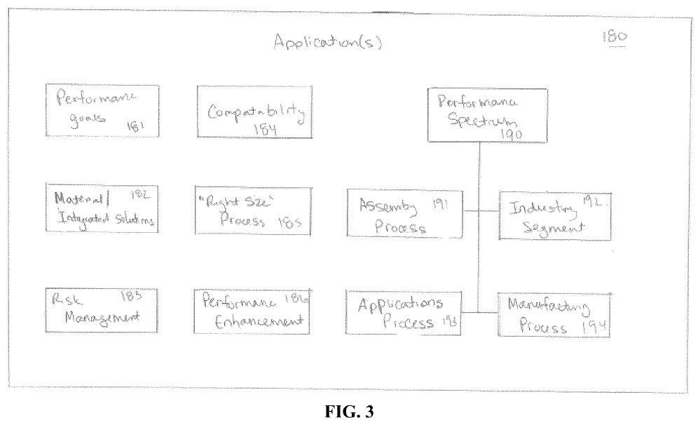

FIG. 3 illustrates various “Applications” 180 coinciding with data sets or data subsets that may be presented to the user via the GUI. These “Applications” 180 include for example, performance goals 181, material solutions and integrated solutions 182, risk management 183, compatibility 184, “right size” processing 185, performance enhancements 186, and performance spectrum 190, which provides data/information related to a continuum of material solutions and/or integrated solutions regarding possible joining materials.

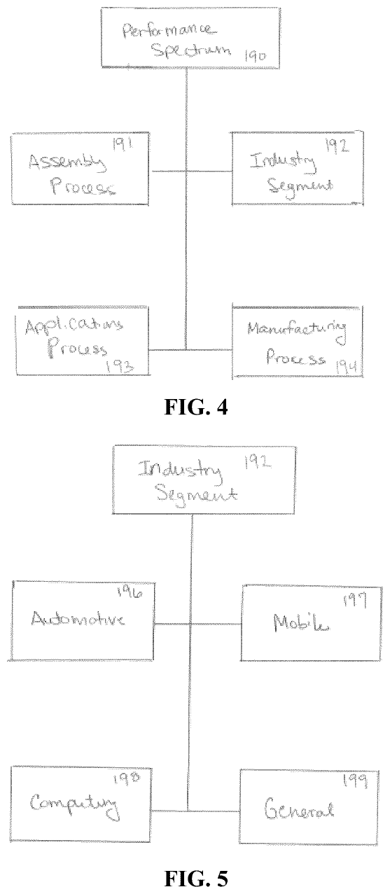

In addition, it is noted that the performance spectrum 190 may organize and/or present data for a particular assembly process 191 or industry segment 192 or applications process 193 or manufacturing process 194 as also shown in FIG. 4. The performance spectrum 190 may be further broken down/defined to provide comparative data for various joining solutions and/or integrated solutions for various products or market segments. For example, in the case of particular industry segments 192, for joining materials and solutions used in the manufacture of electronics products, the GUI may present data for industry segments 192 such as the automotive industry 196, the mobile device industry 197, the computing industry 198 and the general electronics industry 199 by way of example and not limitation as shown in FIG. 5. Other industry segments and/or definitions of industry segments or sub-segments could also be defined.

In one embodiment, the reliability enhancement tool described herein can be shared with a customer by providing the customer with a temporary link. In another embodiment, the reliability enhancement tool can be shared with a customer by directly engaging with the customer to demonstrate the tool.

In one embodiment, the present invention relates generally to a computer-implemented method for demonstrating differentiated performance between integrated solutions used for joining components (PCB, PWB, interconnect, etc.), wherein the computer-implemented method comprises at least a processor to execute instructions, a memory therein to store instructions, and a database populated with data related to joining materials, wherein the database is accessible by the processor, wherein the computer implemented method is executed within a host organization, wherein the method comprises:
executing instructions via the processor to generate a graphical user interface (GUI) at a user computing device to display differentiated performance between a plurality of integrated solutions, wherein each of the plurality of integrated solutions comprises one or more joining materials;
populating the GUI with the data related to the joining materials;
transmitting the GUI to the user computing device for display, wherein the GUI displays information to demonstrate differentiated performance between the plurality of integrated solutions,
   wherein the plurality of integrated solutions comprise a baseline integrated solution, wherein the baseline integrated solution comprises a baseline joining material or baseline plurality of joining materials, and a continuum of one or more additional integrated solutions measured against the baseline integrated solution, wherein each of the one more additional integrated solutions comprise one or more additional joining materials in addition to the baseline joining material or baseline plurality of joining materials;
   wherein the GUI is configured to display a graphical representation of the plurality of integrated solutions, wherein the graphical representation provides product properties for each of the plurality of integrated solutions, wherein the product properties of the integrated solution are different from the product properties of individual joining materials that make up the integrated solution,
   wherein the graphical representation is arranged such that one of an X-axis and a Y-axis identifies and displays a property of the integrated solution and the other of the X-axis or Y-axis identifies the integrated solution, wherein the data is arranged so that a first row/column constitutes the baseline integrated solution;
   wherein an intersection of an X- and Y-data point represents a particular property for a particular integrated solution;
wherein the method further comprises:
based on a selection of an intersection of a particular X-Y-data point, generating a pop-up window to display a visualization of product information related to data/support/analysis of the baseline integrated solution or a visualization of product information related to data/support/analysis of the particular integrated solution as compared with the baseline integrated solution to be indicative of increased performance at the system level;
based on a selection of a product property on the X- or Y-axis, generating a pop-up window to display a visualization of information related to test data, performance data, and conditions used to generate the information related to the data/support/analysis of the plurality of integrated solutions; and/or
based on a selection of an integrated solution on the X- or Y-axis, generating a pop-up window to display a visualization of information related to the integrated solution.

As described herein, these integrated solutions may be, for example, selected from the group consisting of two or more specialty electronic materials including, but not limited to, solders, sinter materials, fluxes, chemicals, polymers, metals (in various forms), films, and other joining materials that present themselves in intimate physical contact with each other and with other substrate surfaces in electronics applications when they are put in use.

The inventors of the present invention have discovered that the method and system described herein provide an improved GUI tool for demonstrating/analyzing/optimizing an increased system level reliability performance or enabling technology. This GUI tool is supported by a knowledge base/test data/performance data that are derived from a unique combinations of test methods, test vehicles and test vehicle preparation to validate performance of material solutions and/or integrated solutions when joining materials are used in combination.

Compatibility and synergistic performance of the integrated solutions are demonstrated to mitigate or eliminate entirely, multiple clearly defined risk factors associated with using these kinds of materials in combination based on differing requirements by industry segment or industry defined testing regimes.

The GUI described herein demonstrates that material combinations in specific integrated solutions overcome certain ever-present potential failure modes.

In another embodiment, the present invention also relates generally to a system comprising:
a. a processor for executing instructions;
b. a database populated with data related to joining materials, wherein the database is accessible by the processor, and
c. memory operably connected to the processor, the memory having instructions executable by the processor, the instructions including:
   executing via the processor the generation of a graphical user interface (GUI) at a user computing device to display differentiated performance between a plurality of integrated solutions, wherein each of the plurality of integrated solutions comprises one or more joining materials;
   populating the GUI with the data related to the joining materials;
   displaying the GUI on the user computing device, wherein the GUI displays information to demonstrate differentiated performance between the plurality of integrated solutions,
      wherein the plurality of integrated solutions comprise a baseline integrated solution, wherein the baseline integrated solution comprises a baseline joining material or baseline plurality of joining materials, and a continuum of one or more additional integrated solutions measured against the baseline integrated solution, wherein each of the one more additional integrated solutions comprise one or more additional joining materials in addition to the baseline joining material or baseline plurality of joining materials;
      wherein the GUI is configured to display a graphical representation of the plurality of integrated solutions, wherein the graphical representation provides product properties for each of the plurality of integrated solutions, wherein the product properties of the integrated solution are different from the product properties of individual joining materials that make up the integrated solution,
      wherein the graphical representation is arranged such that one of an X-axis and a Y-axis identifies and displays a property of the integrated solution and the other of the X-axis or Y-axis identifies the integrated solution, wherein the data is arranged so that a first row/column constitutes the baseline integrated solution;
      wherein an intersection of an X- and Y-data point represents a particular property for a particular integrated solution.

In another embodiment, the present invention also relates generally to a computer program product embodied in a non-transitory computer readable medium, the computer readable medium having stored thereon a sequence of instructions which, when executed by a processor causes the processor to execute a method to present differentiated performance data for integrated solutions used for joining components to a user, the method comprising:
providing a series of graphical user interfaces (GUIs) to display (i) integrated solutions for a particular industry segment, manufacturing process, or applications process; and (ii) sequentially display multiple depths of information pertaining to the differentiated performance data for a plurality of integrated solutions;
generating a first graphical user interface comprising one or more first level view icon, the one or more first level view icons displaying a selection of industry segments, manufacturing processes, or applications processes;
upon selection of one of the first level view icons, generating a second graphical user interface, the second graphical user interface displaying information directed to differentiated performance between the plurality of
   integrated solutions, wherein the plurality of integrated solutions comprise a baseline integrated solution, wherein the baseline integrated solution comprises a baseline joining material or baseline plurality of joining materials, and a continuum of one or more additional integrated solutions measured against the baseline integrated solution, wherein each of the one more additional integrated solutions comprise one or more additional joining materials in addition to the baseline joining material or baseline plurality of joining materials;
   wherein the second GUI is configured to display a graphical representation of the plurality of integrated solutions, wherein the graphical representation provides product properties for each of the plurality of integrated solutions, wherein the product properties of the integrated solution are different from the product properties of individual joining materials that make up the integrated solution,
   wherein the graphical representation is arranged such that one of an X-axis and a Y-axis identifies and displays a property of the integrated solution and the other of the X-axis or Y-axis identifies the integrated solution, wherein the data is arranged so that a first row/column constitutes the baseline integrated solution;
wherein an intersection of an X- and Y-data point represents a particular property for a particular integrated solution.

In one embodiment, the computer program product further comprises:
generating additional graphical user interfaces to display information related to one or more of quality and/or performance and/or reliability goals, quality and/or performance and/or reliability solutions; and risk mitigation for analyzing/determining/computing performance data of one or more of the plurality of integrated solutions, wherein the additional graphical user interfaces each comprise one or more view icons to differentiate/highlight/display the information to the user.

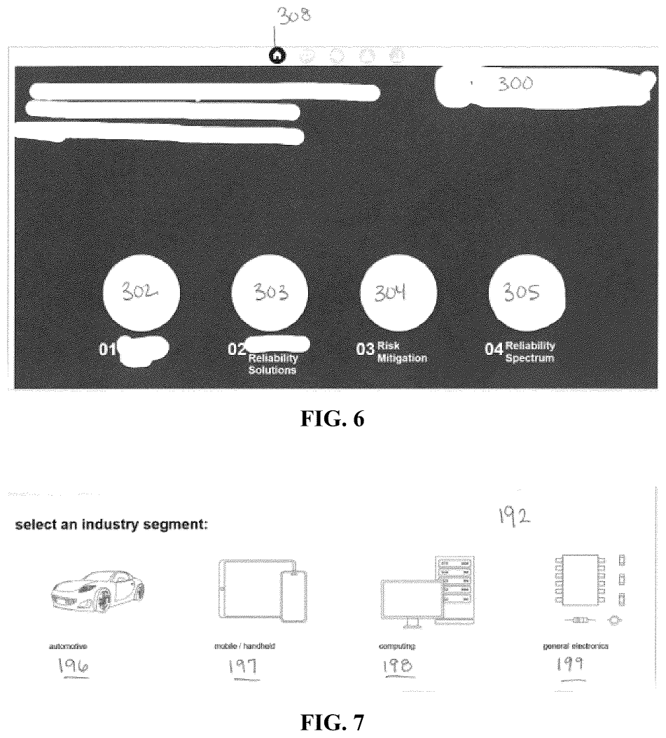

An example of a GUI in accordance with the instant invention is shown in FIGS. 6-21 and is explained in detail below.

Upon request of a user of a computing device 102 to access a dataset stored in Data Storage 170, a graphical representation of the information associated with the requested dataset is presented to the user via the display device 120. As shown in FIG. 6, this request is in the form of interaction with a graphical user interface (GUI), produced by the processor 115 executing the interface module 125. FIG. 6 depicts a home screen 300 that is viewed by a user of a computing device 102 upon launch of the GUI. The home screen 300 provides a plurality of navigation tiles 302, 303, 304, and 305 to provide navigation to additional display screens of the GUI. Navigation between different display screens can also be accomplished by navigation icons 308 which are shown at the top of the display screen.

For example, if a user selects navigation tile 305 (or the navigation icon associated therewith), the user is presented with a different display screen as shown in FIG. 7 which provides an additional series of navigation tiles linked to different industry segments 192 and the user may select a particular industry segment. The industry segments 192 depicted in FIG. 7 correspond to the industry segments 192 shown in FIG. 5. The industry segments may include, for example, the automotive industry 196, the mobile device industry 197, the computing industry 198, and the general electronics industry 199, among others. These industry segments are only examples of different industry segments that can be used with the integrated solutions described herein. It is contemplated that one skilled in the art could also include other industry segments if desired.

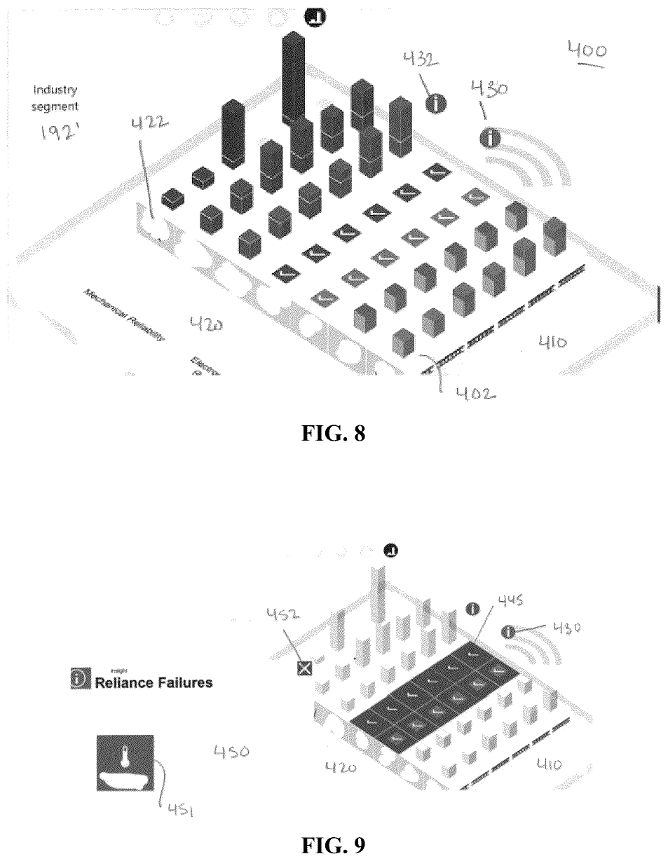

Upon selection of a particular industry segment 196, 197, 198, or 199, as shown in FIG. 8, a graphical representation of a data set is presented to the user for exploration that corresponds to a particular industry segment 192′. In this graphical representation, the X-axis 420 contains headings (not shown) directed to specific properties and/or information related to the various material solutions and/or integrated solutions and the Y-axis 410 provides headings (not shown) directed to specific material solutions and/or integrated solutions. In addition, in some embodiments, an icon 422 (not shown) of the specific property or integrated solution may also be provided. The headings 420, 410 and/or the icon 422 may be selectable (i.e., “clickable” or otherwise engageable) which causes the GUI to display additional information on the selected property and/or integrated solution.

The properties related to the various integrated solution may include mechanical reliability, electrochemical reliability, and cost analysis. Mechanical reliability properties may include thermal cycling, vibration, and/or drop shock. Electrochemical reliability properties may include surface insulation resistance (SIR), cure kinetic interactions, and/or adhesion strength. Cost analysis properties may include material costs and/or processing costs. A first row/column of data in the graphical representation is typically designated the baseline and forms the basis for comparisons of various material solutions and/or integrated. In one embodiment, the baseline may be the first row/column 402 in the graphical representation. Icons 430 and 432 designated “i” provide insights to further highlight or define features depicted in the graphical representation of the data when the user selects (i.e., “clicks on” or otherwise engages) the icons which causes the GUI to display additional information.

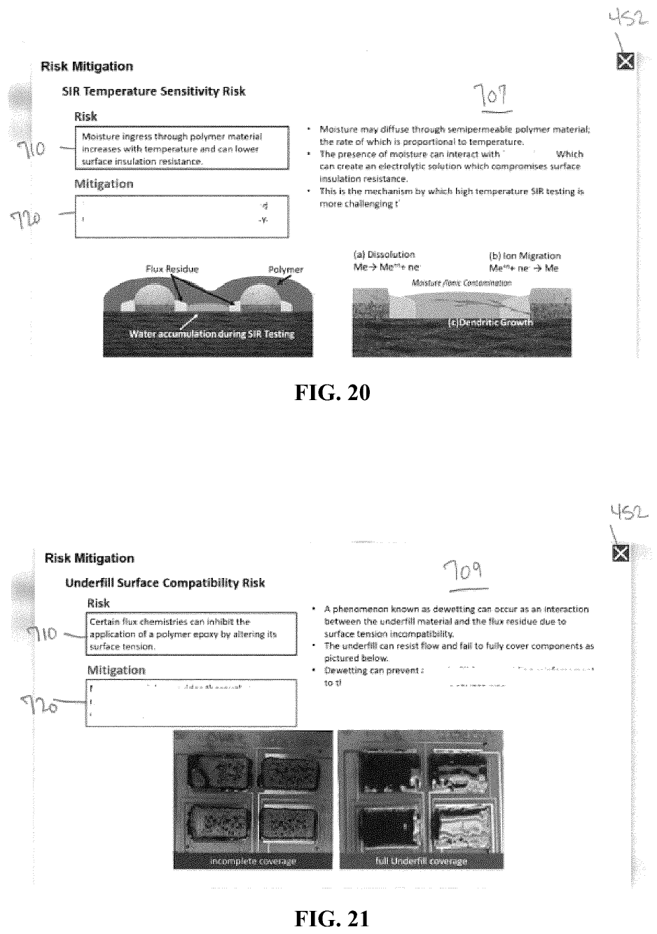

For example, if a user selects “i” indicated as 430 as shown in FIG. 9, columns 445 are highlighted or emphasized. This highlighting or emphasizing may be accomplished by filling in the columns with color and/or a cross-hatching pattern or by otherwise bringing emphasis to the certain area of the display. In addition, the display also provides a “pop-up” display 450 with additional insights on data contained in the columns highlighted in the graphical display. Selecting icon 451 within the “pop-up” display 450 yields additional information, which may include, for example, insights related to risk factors and risk mitigation, solution failures, material interactions etc. For example, for this particular solution, selecting icon 451 will display the information set forth in FIG. 20 below. Alternatively (or in addition), other data or information which may provide insights regarding the particular property or solution may be displayed in this pop-up display. In addition, other insights may be displayed upon selection of “i” 432. Selecting “X” 452 closes the pop-up window and returns the user to the prior screen.

When a “pop-up” display or pop-up window with additional insights is provided, the graphical representation may remain in the background in a paused or suspended state. Once the “pop-up” display or window closes, the graphical representation of a particular industry segment 192 or 192′ may resume functionality and interactivity.

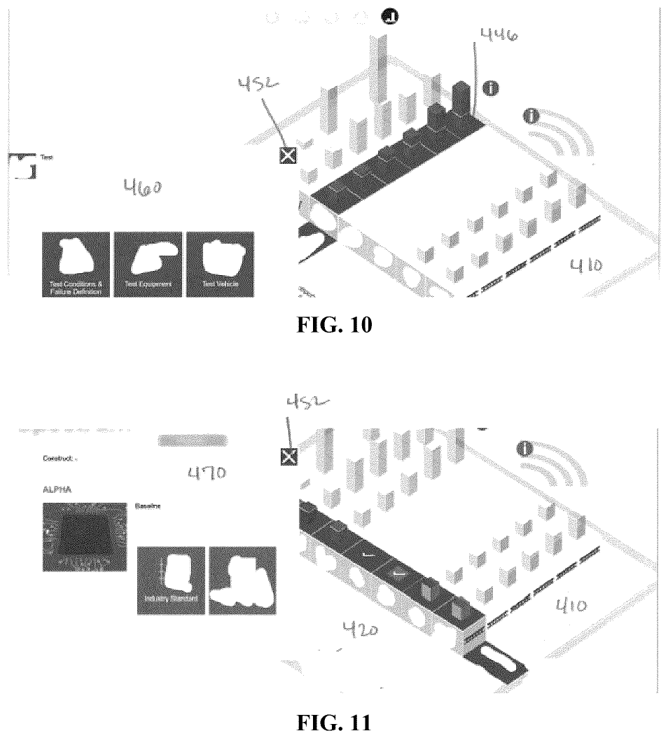

As shown in FIG. 10, if a user selects a particular property depicted on X-axis 420 or icon 422, the column 446 corresponding to the particular property is highlighted or emphasized. Information related to test conditions and failure definition, test equipment and test vehicles are shown in a pop-up window 460. By selecting any one of the navigation tiles (i.e., “test conditions & failure definition,” “test equipment” or “test vehicle,” additional information on the test conducted can be considered (it is noted that this is only an example of the information that may be displayed regarding additional information and that other/different information may be shown and/or the information may be arranged in a different manner). Again, by selecting “X” 452, the one or more pop-up windows can be closed.

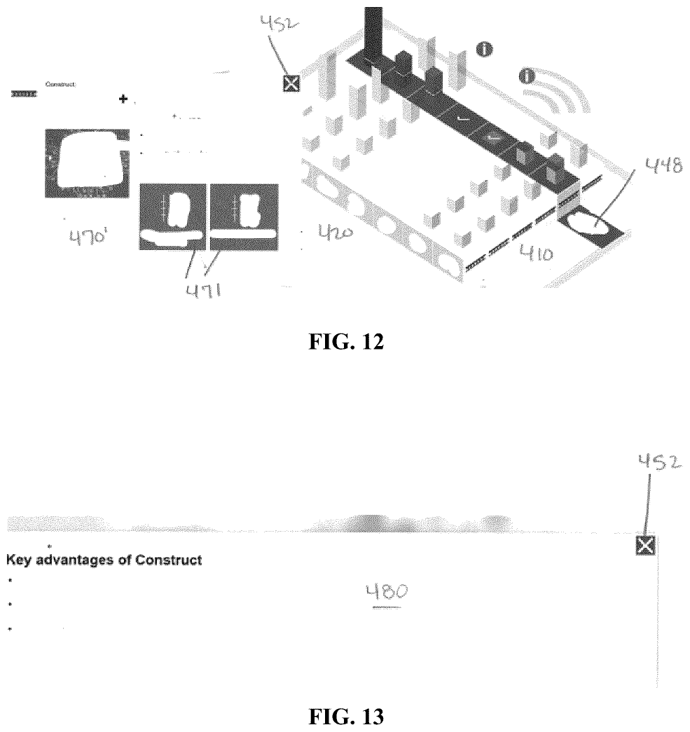

In a similar fashion, and as shown in FIGS. 11 and 12, if a user selects a particular joining material/material solution/integrated solution from those arranged on the Y-axis 410 or icon 422, the row 447, 448 associated with the material/solution is highlighted or emphasized. Data related to properties of the material/solution are also shown in a pop-up window. FIG. 11 depicts a baseline solution 447 being shown while FIG. 11 depicts a different solution 448 on the continuum as shown. In both FIGS. 11 and 12, pop-up windows 470, 470′ provides information on the materials/material solution, which can be further explored by selecting navigation tile 471 to allow a user to explore additional features/advantages of the selected material/material solution in a pop-up window 480 as shown in FIG. 13. The additional features/advantages may be illustrated by a comparison to the baseline solution. By selecting “X” 452, the one or more pop-up windows can be closed.

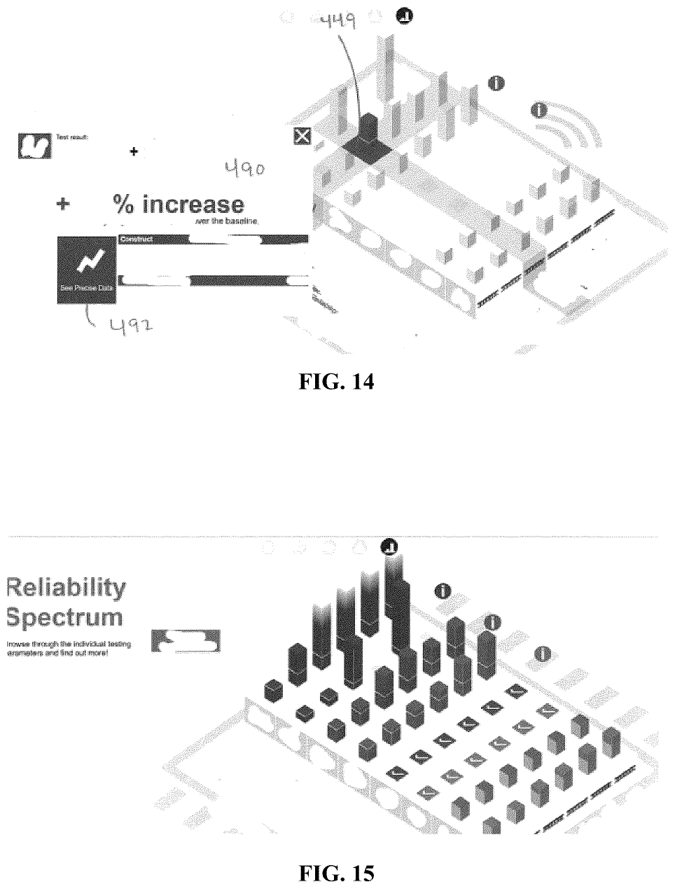

As shown in FIG. 14, if an X-Y-data point 449 is selected corresponding to a particular joining material/material solution/integrated solution (Y-axis) and a particular test parameter or performance parameter (X-axis), that X-Y-data point 449 is highlighted or emphasized and a pop-up window 490 is provided to provide data related to the particular combination and a positive increase/change over the baseline. In addition, if icon 492 is selected, precise data concerning the particular combination of joining materials/material solution/integrated solution is shown to the user in a pop-up window that displays data/process conditions/etc. for the particular combination of materials/material solution/integrated solution. The precise data may also be shown as a performance comparison to the baseline solution.

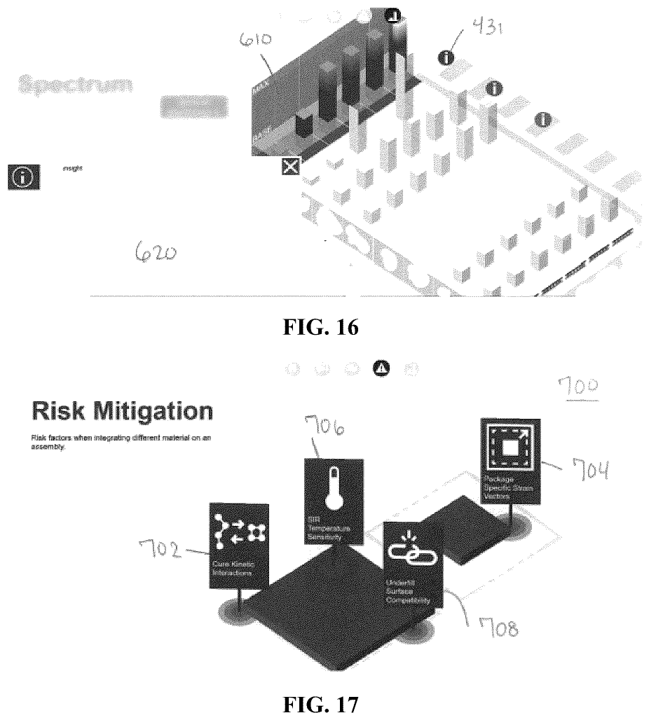

FIGS. 15 and 16 depict a different industry segment. As shown in FIGS. 15 and 16, depending on the industry segment, different test data/performance data/information may be included and different insights may be included as indicated by “i” 431. By selecting this “i” 431, a different display is provided which shows the baseline and max as a graphical representation 610 which is further explained in pop-up window 620. By selecting “X” 452, the pop-up window can be closed.

Another important aspect of the present invention is the characterization of risks that may occur as a result of using incompatible materials. Thus, an important feature of the present invention also involves understanding the risks associated with incompatible materials or adverse material interactions that can occur in specific applications. Therefore, in one embodiment, the present invention is also directed to the characterization and mitigation/minimization of negative material interactions. This can also be realized by a corresponding increased performance at the system level resulting from the use of one of the integrated solutions that are demonstrated to have a differentiated performance and shown to be suitable as integrated solutions for use with particular substrate surfaces, in electronics applications, which may vary based on a particular industry segment, assembly process, applications process, or manufacturing process and with certain package designs or for use under high stress or other distinctive conditions.

Thus, turning again to FIG. 6, which depicts a home screen 300 that is viewed by a user of a computing device 102 upon launch of the GUI. The home screen 300 provides a plurality of navigation tiles 302, 303, 304, and 305 to provide navigation to additional display screens of the GUI. Navigation between different display screens can also be accomplished by navigation icons 308 which are shown at the top of the display screen. In this instance, if a user selects navigation tile 304 (or the navigation icon associated therewith), the user is presented with a different display screen as shown in FIG. 17 which displays information related to risk factors and risk mitigation when integrating different materials on an assembly.

As seen in FIG. 17, the GUI provides navigation icons directed to “Cure Kinetic Interactions” 702, “Package Specific Strain Vectors” 704, “SIR Temperature Sensitivity” 706 and “Underfill Surface Compatibility” 708. As should be apparent to one skilled in the art, these navigation icons may be differently named and/or there may be additional navigation icons for additional risk factors depending on the particular integrated solutions being presented or as additional information becomes available.

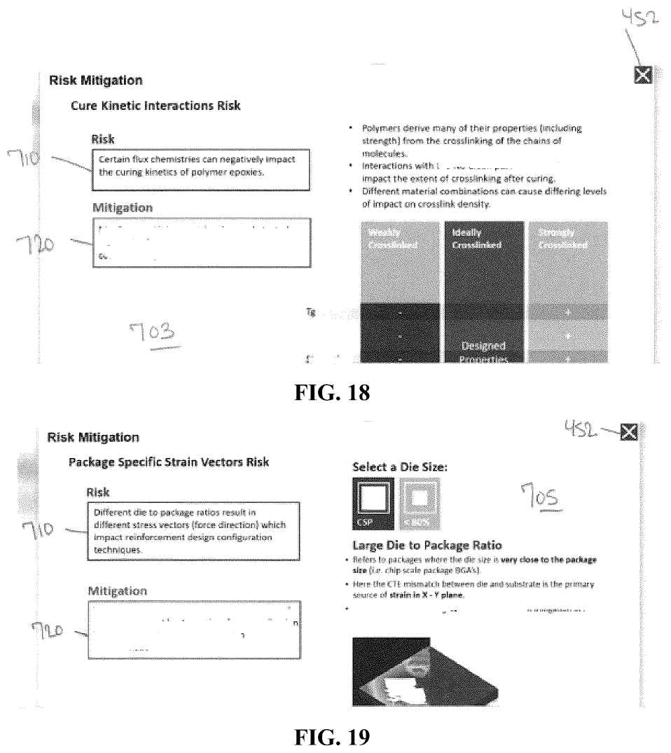

Upon selection of one of navigation tiles/icons 702, 704, 706, or 708, a graphical representation of associated risk factors, risk mitigation, and information related to the specific risk factor is shown to the user in a pop-up window. For example, upon selection of the navigation tile/icon for Cure Kinetic Interactions 702, a pop-up window 703 is displayed to the user as shown in FIG. 18. As also shown in FIG. 18, information explaining the specific risks 710 and the specific risk mitigation 720 is displayed to the user along with additional information that may assist the user in understanding and differentiating the particular risks. Likewise, as shown in FIG. 19, upon selection of the navigation tile/icon for Package Specific Strain Vectors 704, a pop-up window 705 is displayed for to the user detailing risk associated information on this particular topic. Similarly in FIGS. 20 and 21, up selection of the navigation tile/icon 706 or 708, a pop-up window 707 or 709 respectively is displayed to the user. As with any of the other pop-up windows described herein, by selecting “X” 452, the pop-up window can be closed.

As described herein the computer-implemented method and system described herein demonstrate a unique ability to effectively communicate:
1) An extremely large, complex and unique data set supporting the recommendation to utilize various materials solutions in combination;
2) Indicative performance in critical technical requirements, specific to individual material sets and industry segment specific testing regimes which supports customer design level material selection processes which can be made available for a particular application;
3) Enabling technology for a customer/user to implement new more demanding performance requirements driven by new circuit board designs, semiconductor package designs and increasing levels of reliability requirements;
4) Improved system level reliability; and
5) Ability to reduce their total cost of ownership while still meeting technical specifications.

This interactive digital tool seamlessly presents:
1) Test methods, conditions, failure criteria, equipment sets, test vehicle preparation criteria, performance data, performance criteria, cost of ownership, etc.;
2) A continuum of various integrated material solution sets;
3) Performance improvement of a range of integrated solution material sets as measured against baseline industry standards that assist in a customer/user's decision making process; and
4) Risk factors and risk mitigation techniques to evaluate risks associated with the use of incompatible joining materials, etc. to assist a customer with evaluating and selecting a particular integrated solution that meets their needs.

A customer for which the tool described herein may be useful include one in which the customer:
a. Is challenged with a new component/reliability requirement;
b. Understands the different constructs available and is considering a recommended solution;
c. Is considering a solution for evaluation as a second source; and/or
d. Wants to understand options available to reduce total cost of ownership).

Examples of risk factors presented when integrating different materials on an assembly include, but are not limited to:
a. Package specific strain vectors-different “package: die ratios” create varying strain modes (i.e., in different XYZ vectors) and require appropriate reinforcement strategies;
b. Cure kinetic interactions-chemical interactions can alter polymer curing kinetics of polymers;
c. SIR temperature sensitivity-polymer reinforcements are more susceptible to SIR failure at higher thermal profiles; and/or
d. Underfill surface compatibility-ineffective underfill/paste flux combinations can result in low adhesion strength and/or SIR failure.

Risk management based on the use of various integrated solutions can also be assessed/evaluated/calculated and that information included in the data set stored in Data Storage 170 for access by the system. For example, polymer reinforcement materials in combination with flux reside can interact to accelerate electrochemical failure resulting from incomplete curing, moisture ingress at elevated temperatures and humidity, etc. In addition, mechanical properties, such as mechanical vibration, and package considerations, such as surface mount packaging, such as ball grid array (BGA) architecture determining stress induced behavior of a device during thermal cycling and mechanical properties of adhesives can also be assessed/evaluated/calculated to mitigate risk.

SIR testing of the various joining materials and integrated solutions containing one or more of the joining materials demonstrated that many integrated solution sets of joining materials failed in SIR testing. While each material by itself is of high quality, interaction within the integrated solution can cause failures. This demonstrates the necessity of knowing which materials work in concert with each other which can only be validated by extensive testing and evaluation of the combination of materials. This test and/or performance data is stored in Data Storage 170 and can be accessed by the user on the user interface 140 for each particular material solution/integrated solution. It should also be pointed out that any untested combinations yield a significant chance of failure. That is, utilizing the tool described herein can ensure appropriate integration solutions with qualified assembly while at the same time minimizing risks resulting from the use of incompatible materials or materials that have not been evaluated or tested for compatibility.

As used herein, the term “joining material” refers generally to a solder paste, other soldering material, sintering materials, adhesives, glue, flux, chemicals, polymers, metals (in various forms), films, protection materials, reinforcement solutions, etc. used for binding, joining, bonding or otherwise connecting components, layers, surfaces, boards (i.e., PWB, PCB), innerlayers, etc. in the electronics industry.

As used herein, “a,” “an,” and “the” refer to both singular and plural referents unless the context clearly dictates otherwise.

As used herein, the term “about” refers to a measurable value such as a parameter, an amount, a temporal duration, and the like and is meant to include variations of +/−15% or less, preferably variations of +/−10% or less, more preferably variations of +/−5% or less, even more preferably variations of +/−1% or less, and still more preferably variations of +/−0.1% or less of and from the particularly recited value, in so far as such variations are appropriate to perform in the invention described herein. Furthermore, it is also to be understood that the value to which the modifier “about” refers is itself specifically disclosed herein.

As used herein, spatially relative terms, such as “beneath,” “below,” “lower,” “above,” “upper” and the like, are used for ease of description to describe one element or feature's relationship to another element(s) or feature(s) as illustrated in the figures. Spatially relative terms may be intended to encompass different orientations of the device in use or operation in addition to the orientation depicted in the figures.

As used herein, the terms “comprises” and/or “comprising,” specify the presence of stated features, integers, steps, operations, elements, and/or components, but do not preclude the presence or addition of one or more other features, integers, steps, operations, elements, components, and/or groups thereof.

What is claimed is:

1. A computer-implemented method for demonstrating differentiated performance between integrated solutions used for joining components, wherein the computer-implemented method comprises at least a processor to execute instructions, a memory therein to store instructions, and a database populated with data related to joining materials, wherein the database is accessible by the processor, wherein the computer implemented method is executed within a host organization, wherein the method comprises:
executing instructions via the processor, wherein the processor is programmed to (a) access data stored in the database, and (b) generate a graphical user interface (GUI) at a user computing device to display a graphical representation of differentiated performance between a plurality of integrated solutions, wherein each of the plurality of integrated solutions comprises one or more joining materials;
populating the GUI with the data related to the joining materials, wherein the data related to the joining materials and their properties is stored in the database;
transmitting the GUI to the user computing device for display, wherein the GUI displays information to demonstrate differentiated performance between the plurality of integrated solutions,
wherein the plurality of integrated solutions comprise a baseline integrated solution, wherein the baseline integrated solution comprises a baseline joining material or baseline plurality of joining materials, and a continuum of one or more additional integrated solutions measured against the baseline integrated solution, wherein each of the one more additional integrated solutions comprise one or more additional joining materials in addition to the baseline joining material or baseline plurality of joining materials;
wherein the GUI is configured to display a graphical representation of the plurality of integrated solutions, wherein the graphical representation provides product properties for each of the plurality of integrated solutions, wherein the product properties of the integrated solution are different from the product properties of individual joining materials that make up the integrated solution,
wherein the graphical representation is arranged such that one of an X-axis and a Y-axis identifies and displays a property of the integrated solution and the other of the X-axis or Y-axis identifies the integrated solution, wherein the data is arranged so that a first row/column constitutes the baseline integrated solution;
wherein an intersection of an X- and Y-data point represents a particular property for a particular integrated solution;
wherein the method further comprises:
based on a selection of the intersection of a particular X-Y-data point, generating a pop-up window to display a visualization of product information related to data/support/analysis of the baseline integrated solution or a visualization of product information related to data/support/analysis of the particular integrated solution as compared with the baseline integrated solution to be indicative of increased performance at the system level;
based on a selection of a product property on the X- or Y-axis, generating a pop-up window to display a visualization of information related to test data, performance data, and conditions used to generate the information related to the data/support/analysis of the plurality of integrated solutions; and/or
based on a selection of an integrated solution on the X- or Y-axis, generating a pop-up window to display a visualization of information related to the integrated solution.

2. The method of claim 1, wherein the GUI comprises a plurality of GUIs, each of which constitutes integrated solutions for a particular industry segment, manufacturing process, or applications process.

3. The method of claim 1, wherein the product property constitutes one or more of mechanical reliability, electrochemical reliability, and cost analysis.

4. The method of claim 1, wherein the joining materials are selected from the group consisting of solder materials, solder pastes, glues, adhesives, polymers, resins, sintering materials, protection materials, reinforcement materials, other bonding and joining materials commonly used in electronics manufacturing, and combinations of the foregoing.

5. The method of claim 1, wherein the GUI is configured to convey information related to risk factors and risk mitigation strategies for the joining materials and the integrated solutions comprising the joining materials.

6. The method of claim 1, wherein the graphical representation remains in a suspended state when the pop-up window is displayed.

7. A system comprising:
a. a processor for executing instructions, wherein the processor is programmed to (a) access data stored in a database, and (b) generate a graphical representation of a plurality of joining materials and their properties;
b. a database populated with data related to the joining materials and their properties, wherein the database is accessible by the processor, and
c. memory operably connected to the processor, the memory having instructions executable by the processor, the instructions including:
executing via the processor the generation of a graphical user interface (GUI) at a user computing device to display differentiated performance between a plurality of integrated solutions, wherein each of the plurality of integrated solutions comprises one or more joining materials;
populating the GUI with the data related to the joining materials and their properties;
displaying the GUI on the user computing device, wherein the GUI displays information to demonstrate differentiated performance between the plurality of integrated solutions,
wherein the plurality of integrated solutions comprise a baseline integrated solution, wherein the baseline integrated solution comprises a baseline joining material or baseline plurality of joining materials, and a continuum of one or more additional integrated solutions measured against the baseline integrated solution, wherein each of the one more additional integrated solutions comprise one or more additional joining materials in addition to the baseline joining material or baseline plurality of joining materials;
wherein the GUI is configured to display a graphical representation of the plurality of integrated solutions, wherein the graphical representation provides product properties for each of the plurality of integrated solutions, wherein the product properties of the integrated solution are different from the product properties of individual joining materials that make up the integrated solution,
wherein the graphical representation is arranged such that one of an X-axis and a Y-axis identifies and displays a property of the integrated solution and the other of the X-axis or Y-axis identifies the integrated solution, wherein the data is arranged so that a first row/column constitutes the baseline integrated solution;
wherein an intersection of an X- and Y-data point represents a particular property for a particular integrated solution.

8. The system of claim 7, wherein the system further comprises:
based on a selection of the intersection of a particular X-Y-data point, generating a pop-up window to display a visualization of product information related to data/support/analysis of the baseline integrated solution or a visualization of product information related to data/support/analysis of the particular integrated solution as compared with the baseline integrated solution to be indicative of increased performance at the system level;
based on a selection of a product property on the X- or Y-axis, generating a pop-up window to display a visualization of information related to test data, performance data, and conditions used to generate the information related to the data/support/analysis of the plurality of integrated solutions; and/or
based on a selection of an integrated solution on the X- or Y-axis, generating a pop-up window to display a visualization of information related to the integrated solution.

9. The system of claim 7, wherein the GUI comprises a plurality of GUIs, each of which constitutes integrated solutions for a particular industry segment, manufacturing process, or applications process.

10. The system of claim 7, wherein the product property constitutes one or more of mechanical reliability, electrochemical reliability, and cost analysis.

11. The system of claim 7, wherein the joining materials are selected from the group consisting of solder materials, solder pastes, glues, adhesives, polymers, resins, sintering materials, protection materials, reinforcement materials, other bonding and joining materials commonly used in electronics manufacturing, and combinations of the foregoing.

12. The system of claim 7, wherein the GUI is configured to convey information related to risk factors and risk mitigation strategies for the joining materials and the integrated solutions comprising the joining materials.

13. The system of claim 8, wherein the graphical representation remains in a suspended state when the pop-up window is displayed.

14. A computer program product embodied in a non-transitory computer readable medium, the computer readable medium having stored thereon a sequence of instructions which, when executed by a processor causes the processor to execute a method to present differentiated performance data for integrated solutions used for joining components to a user, the method comprising:
providing a series of graphical user interfaces (GUIs) to display (i) integrated solutions for a particular industry segment, manufacturing process, or applications process; and (ii) sequentially display multiple depths of information pertaining to the differentiated performance data for a plurality of integrated solutions;
generating a first graphical user interface comprising one or more first level view icons, the one or more first level view icons displaying a selection of industry segments, manufacturing processes, or applications processes;
upon selection of one of the first level view icons, generating a second graphical user interface, the second graphical user interface displaying information directed to differentiated performance between the plurality of integrated solutions,
wherein the plurality of integrated solutions comprise a baseline integrated solution, wherein the baseline integrated solution comprises a baseline joining material or baseline plurality of joining materials, and a continuum of one or more additional integrated solutions measured against the baseline integrated solution, wherein each of the one more additional integrated solutions comprise one or more additional joining materials in addition to the baseline joining material or baseline plurality of joining materials;
wherein the second GUI is configured to display a graphical representation of the plurality of integrated solutions, wherein the graphical representation provides product properties for each of the plurality of integrated solutions, wherein the product properties of the integrated solution are different from the product properties of individual joining materials that make up the integrated solution,
wherein the graphical representation is arranged such that one of an X-axis and a Y-axis identifies and displays a property of the integrated solution and the other of the X-axis or Y-axis identifies the integrated solution, wherein the data is arranged so that a first row/column constitutes the baseline integrated solution;
wherein an intersection of an X- and Y-data point represents a particular property for a particular integrated solution.

15. The computer program product of claim 14, further comprising:
generating additional graphical user interfaces to display information related to one or more of quality and/or performance and/or reliability goals, quality and/or performance and/or reliability solutions; and risk mitigation for analyzing/determining/computing performance data of one or more of the plurality of integrated solutions, wherein the additional graphical user interfaces each comprise one or more view icons to differentiate/highlight/display the information to the user.

16. The computer program product of claim 14, wherein the computer program product further comprises:
based on a selection of the intersection of a particular X-Y-data point, generating a pop-up window to display a visualization of product information related to data/support/analysis of the baseline integrated solution or a visualization of product information related to data/support/analysis of the particular integrated solution as compared with the baseline integrated solution to be indicative of increased performance at the system level;
based on a selection of a product property on the X- or Y-axis, generating a pop-up window to display a visualization of information related to test data, performance data, and conditions used to generate the information related to the data/support/analysis of the plurality of integrated solutions; and/or
based on a selection of an integrated solution on the X- or Y-axis, generating a pop-up window to display a visualization of information related to the integrated solution.

17. The computer program product of claim 14, wherein the product property constitutes one or more of mechanical reliability, electrochemical reliability, and cost analysis.

18. The computer program product of claim 14, wherein the joining materials are selected from the group consisting of solder materials, solder pastes, glues, adhesives, polymers, resins, sintering materials, protection materials, reinforcement materials, other bonding and joining materials commonly used in electronics manufacturing, and combinations of the foregoing.

19. The computer program product of claim 16, wherein the graphical representation remains in a suspended state when the pop-up window is displayed.
